(19) United States
(12) Patent Application Publication
(10) Pub. No.: US 2007/0089269 A1
(43) Pub. Date: Apr. 26, 2007

(54) Mechanism having easily detachable rotation shafts

(75) Inventors: Fang-Yueh Shen, Taoyuan Hsien (TW); Chih-Hsiang Lee, Taoyuan Hsien (TW)

Correspondence Address: TROXELL LAW OFFICE PLLC, Suite 1404, 5205 Leesburg Pike, Falls Church, VA, 22041, US

(73) Assignee: Enlight Corporation

(21) Appl. No.: 11/258,049

(22) Filed: Oct. 26, 2005

(51) Int. Cl. E05D 1/06

(52) U.S. Cl. 16/268

(57) ABSTRACT

A mechanism for pivotally coupling a liftable cover with a faceplate comprises a plurality of rotation shafts. These rotation shafts comprise axial bars and fastener bars. The axial bars are for insertion into shaft sleeves of the liftable cover and shaft sleeves of the faceplate. The fastener bars are for positioning in positioning means that mount on the liftable cover near the shaft sleeves of the liftable cover. As a result, the fastener bars can be rotated for positioning in notches of the positioning means after the axial bars of the rotation shafts pivotally couple the liftable cover with the faceplate such that the rotation shafts can be detached easily by rotationally separating the rotation shafts from the notches. Accordingly, the liftable cover and the faceplate can be assembled or disassembled easily.

### FIELD OF THE INVENTION

The present invention relates to a mechanism having rotation shafts for pivotally coupling a liftable cover with a faceplate, and more particularly to rotation shafts that facilitate attachment and detachment of the liftable cover.

### BACKGROUND OF THE INVENTION

In order to provide an esthetically desirable appearance or attain desirable security and protection, a general box, mounting frame, or even faceplate of a host (e.g., a computer) usually has an additional liftable cover mounted thereon. This general liftable cover is pivotally coupled with the faceplate by fixedly mounted rotation shafts that cannot be detached randomly. As a result, auxiliary tools or other means must be applied to the detachment of the rotation shafts. Sometimes, the liftable cover cannot be detached from the faceplate without destroying the rotation shafts. The liftable cover cannot be attached or detached easily since the auxiliary tools are necessary for the attachment and detachment of the rotation shafts.

### SUMMARY OF THE INVENTION

In view of the above-mentioned problems, the present invention provides an improved mechanism having detachable rotation shafts so as to improve the practicability of various apparatuses.

In accordance with one aspect of the present invention, an easily detachable rotation shaft includes an axial bar and a fastener bar. The axial bar is for insertion into a shaft sleeve of a liftable cover and a shaft sleeve of a faceplate. The fastener bar is for positioning in a positioning means that mounts on the liftable cover near the shaft sleeve of the liftable cover. As a result, the fastener bar can be positioned in a notch of the positioning means after the axial bar of the rotation shaft pivotally couples the liftable cover with the faceplate such that the rotation shaft can be detached easily by rotationally separating the rotation shaft from the notch. Accordingly, the liftable cover and the faceplate can be assembled or disassembled easily.

Other objects and features of the present invention will become apparent from the following detailed description when taken in conjunction with the drawings in which:

### BRIEF DESCRIPTION OF THE DRAWINGS

These and other features, aspects and advantages of the present invention will become better understood with regard to the following description, appended claims, and accompanying drawings, where:

FIG. 1 is an elevational view showing the structure of the present invention;

FIG. 2 is a partial enlarged elevational view showing the section encircled in FIG. 1;

FIG. 3 is an exploded elevational view showing the structure shown in FIG. 2; and

FIG. 4 is an elevational view showing the process for attaching or detaching the rotation shaft of the present invention.

### DETAILED DESCRIPTION OF THE PREFERRED EMBODIMENT

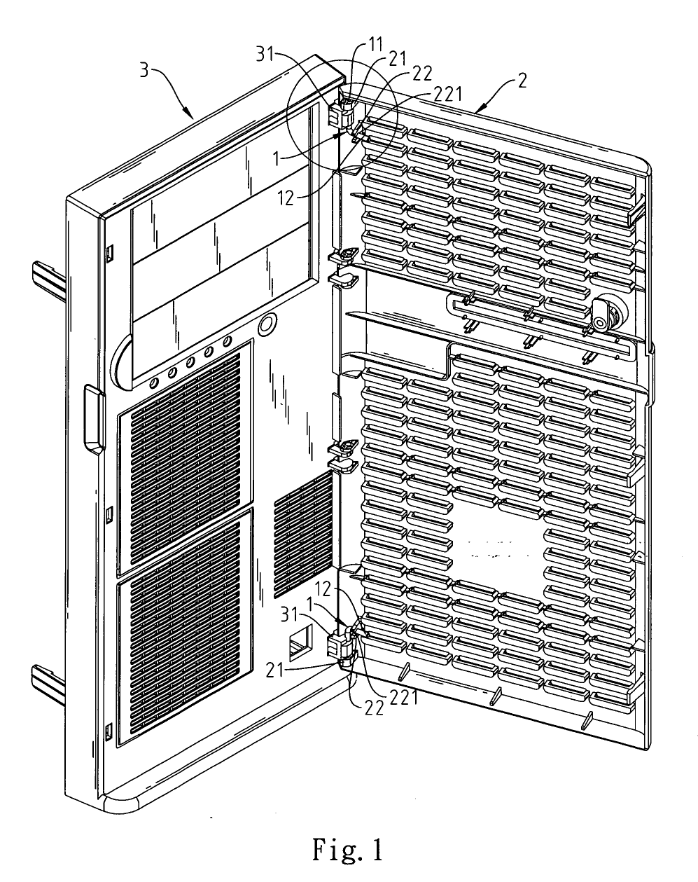

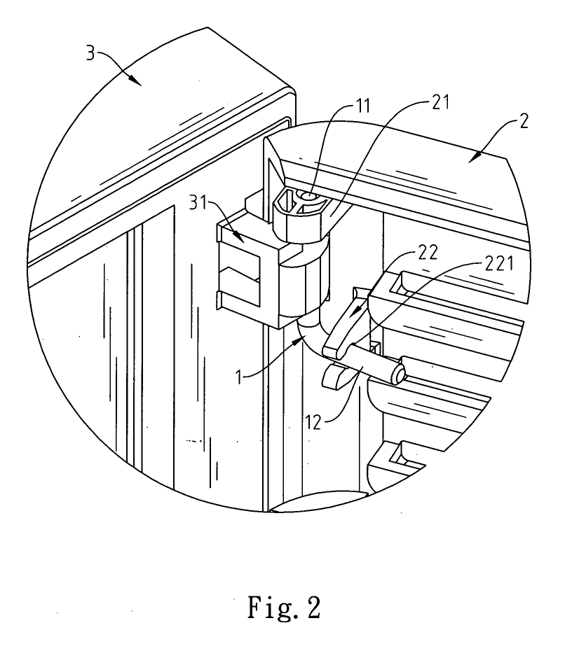

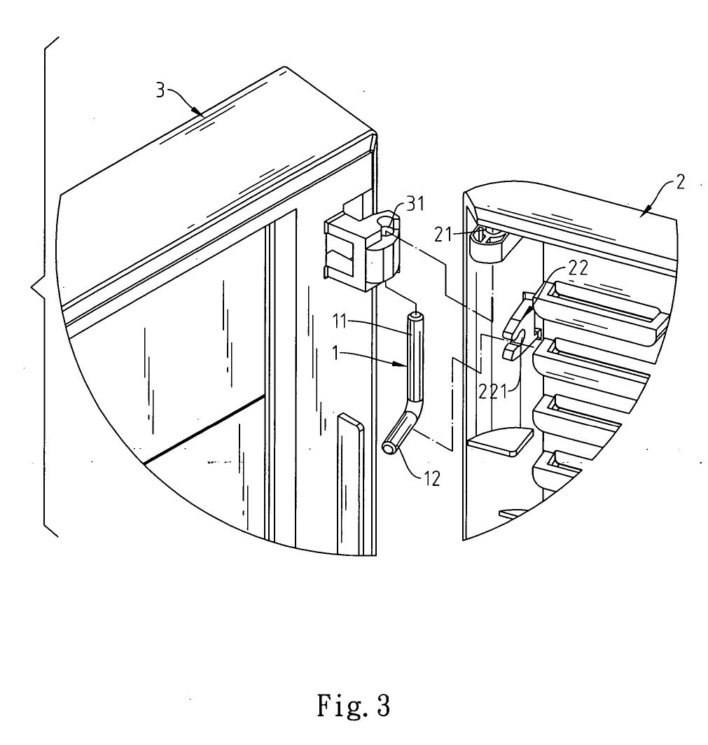

Referring to FIG. 1, FIG. 2 and FIG. 3, a mechanism having easily detachable rotation shafts comprises rotation shafts 1, a liftable cover 2 and a faceplate 3, wherein the liftable cover 2 and the faceplate 3 have corresponding shaft sleeves 21 and shaft sleeves 31 mounted thereon, respectively, for collectively forming through holes into which the rotation shafts 1 are inserted, respectively.

Each of the rotation shafts 1 is composed of two parts, i.e. an axial bar 11 and a fastener bar 12, wherein the axial bars 11 can be inserted into the shaft sleeves 21 of the liftable cover 2 and the shaft sleeves 31 of the faceplate 3 for pivotally coupling the cover 2 with the faceplate 3 such that the liftable cover 2 can be pivotally rotated relative to faceplate 3. Besides, positioning means 22 are mounted on the liftable cover 2 near the corresponding shaft sleeves 21, and notches 221 are formed on top portions of the positioning means 22. The notches 221 of the positioning means 22 can securely grasp the fastener bars 12 of the rotation shafts 1 after the axial bars 11 of the rotation shafts 1 pivotally couple the liftable 2 with the faceplate 3.

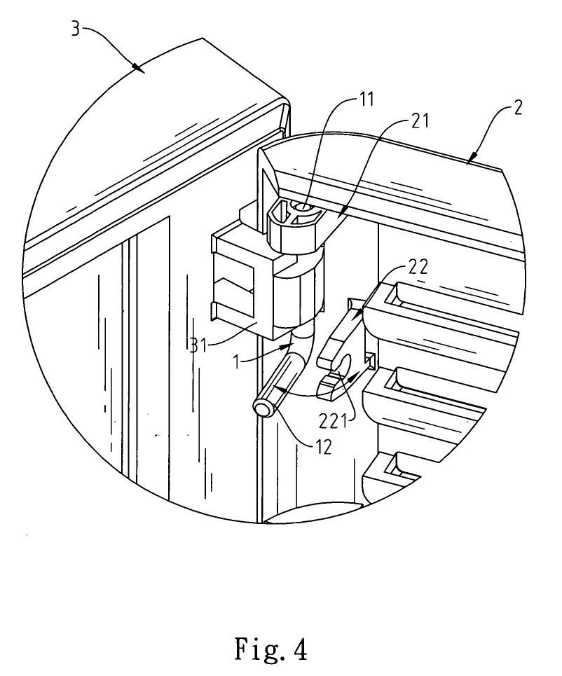

Referring further to FIG. 2 and FIG. 4, when the axial bars 11 of the rotation shafts 1 insert through the shaft sleeves 21 of the liftable cover 2 and the shaft sleeves 31 of the faceplate 3, the fastener bars 12 of the rotation shafts 1 can be rotated by a proper angel for positioning in the notches 221 that form on the positioning means 22. The rotation shafts 1 are rotated together with the liftable cover 2 when the liftable cover 2 is rotated. The rotation shafts 1 can be detached easily by rotationally separating the rotation shafts 1 from the notches 221.

What the invention claimed is:

1. A mechanism for pivotally coupling a liftable cover with a faceplate, comprising:
a plurality of rotation shafts comprising a plurality of axial bars and a plurality of fastener bars, the axial bars being inserted into a plurality of shaft sleeves of the liftable cover and a plurality of shaft sleeves of the faceplate, the fastener bars being positioned in a plurality of positioning means that mount on the liftable cover near the shaft sleeves.

2. The mechanism of claim 1, wherein the axial bars and the fastener bars of the rotation shafts constitute L-shaped structures.
